(19) United States
(12) Patent Application Publication
(10) Pub. No.: US 2005/0052839 A1
(43) Pub. Date: Mar. 10, 2005

(54) Hard disk module mounting structure for notebook computer

(75) Inventors: Der-Jang Sun, Taipei (TW); Yaz-Tzung Wu, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/656,292

(22) Filed: Sep. 8, 2003

(51) Int. Cl. G06F 1/16

(52) U.S. Cl. 361/685

(57) ABSTRACT

The present invention relates to a hard disk module mounting structure provided at one end of a hard disk module receivable in one receiving chamber inside a mainframe shell of a notebook computer, which comprises two brackets respectively fixedly fastened to two opposite lateral sidewalls of the hard disk module near one end remote from an I/O port thereof; a mounting bar pivotally connected between said brackets; and at least one lug fixedly extended from one side of said mounting bar for fastening to said receiving chamber which enables the hard disk module to be conveniently detachably installed in said receiving chamber after the I/O port of the hard disk module being connected to a connector inside the receiving chamber.

### BACKGROUND OF THE INVENTION

1. Field of the Invention

The present invention relates to a hard disk module mounting structure for notebook computer and, more particularly, to such a hard disk module mounting structure, which enables the e hard disk module to be conveniently detachably installed in one receiving chamber inside the mainframe shell of a notebook computer.

2. Description of the Related Art

The modern world we live has entered a new era of high development of information technology. A variety of microprocessor based information products have been continuously developed to serve people. These information products have become a part of our life. Following fast development of information technology, people do more care about the quality of information products, more particularly, notebook computers. It has become one of the indexes to measure the level of the information product manufacturing technology of a country by means of evaluating the convenience and efficiency of the services of notebook computers the country supplied.

The market tendency of mainframe shells for notebook computer is towards a lighter, thinner, shorter, and smaller design. This concept t forces component parts suppliers to develop their products towards miniaturization. There is little difference between microprocessors for notebook computer and microprocessors for desk computer. However, there is a significant difference in performance between a hard disk for notebook computer and a hard disk for desk computer.

Why the performance of a hard disk for notebook computer is inferior to a hard disk for desk computer? The main reason comes from the miniaturization of component parts. In order to perform this design concept, certain hard disk features (for example, data storage capacity or data access speed) are sacrificed. More particularly, after the commercialization of Windows operation system, the impact of the performance of hard disk to the whole computer system is enhanced. Because Windows adopts virtual memory technology, hard disk needs to process swap file of virtual memory. Therefore, the mission of hard disk is not limited to starting system files/programs or reading user's files. This is a thorny problem to manufacturers of hard disks for notebook computer. It is a bottleneck to people in information industry to improve the performance of hard disk for notebook computer. The improvement of the performance of hard disk for notebook computer has become an important index to evaluate the manufacturing technique of a company.

From the aforesaid detailed instruction of hard disk for notebook computer, we understood the existence of problems in miniaturization of notebook computer. Every hard disk supplier has been trying hard to develop smaller, thinner, lighter, and shorter hard disks with higher capacity and access speed to satisfy market demands. However, there are problems during exchange between new generation hard disks and old generation hard disks. These problems are discussed hereinafter.

When installing a hard disk module 2 in a notebook computer's mainframe shell 1, as shown in FIG. 1, the mainframe shell 1 has a receiving chamber 10 and a connector 11 inside the receiving chamber 10, and the hard disk module 2 has an I/O port 20 at one end. When put the hard disk module 2 in the receiving chamber 10, the hard disk module 2 is pushed forwards to force the I/O port 20 into engagement with the connector 11. This connection is not safe. When the notebook computer vibrated or struck by an external body, the I/O port 20 may be forced away from the connector 11, and the user may have to deliver the notebook computer to the distributor or service center for examination if he (she) cannot find the reason of the failure.

In information market, the competition of notebook computer is severe. This severe competition gives much pressure to computer suppliers. However this market competition gives choices to consumers. Every consumer hopes to buy a humanized notebook computer at a reasonable price. Any humanized design of a notebook computer will help the supplier compete with others in the market. Therefore, it is desirable to provide a hard disk module mounting structure that enables the user to rapidly and firmly fasten the hard disk module to the mainframe shell and then conveniently easily disconnect the hard disk module from the mainframe shell.

### SUMMARY OF THE INVENTION

The present invention has been accomplished under the circumstances in view. It is the main object of the present invention to provide a hard disk module mounting structure, which enables the hard disk module to be conveniently detachably installed in one receiving chamber inside the mainframe shell of a notebook computer.

According to the present invention, the hard disk module mounting structure is provided at one end of a hard disk module receivable in one receiving chamber of the mainframe shell of a notebook computer for fastening to the mainframe shell to secure the hard disk module to the inside of the receiving chamber after connection of an I/O port of the hard disk module to a connector inside the receiving chamber. The hard disk module mounting structure comprises two brackets respectively fixedly fastened to two opposite lateral sidewalls of said hard disk module near one end remote from said I/O port; a mounting bar pivotally connected between said brackets; and at least one lug fixedly extended from one side of said mounting bar for fastening to said receiving chamber.

### BRIEF DESCRIPTION OF THE DRAWINGS

FIG. 1 is a perspective view showing the installation of a hard disk module in one receiving chamber inside a mainframe shell for notebook computer according to the prior art.

FIG. 2 is a perspective view showing the installation of a hard disk module in one receiving chamber inside a mainframe shell for notebook computer according to the present invention.

FIG. 3 is an elevational view of a hard disk module mounting structure according to the present invention.

FIG. 4A is a schematic sectional view showing the action of the present invention (I).

FIG. 4B is a schematic sectional view showing the action of the present invention (II).

FIG. 4C is a schematic sectional view showing the action of the present invention (III).

FIG. 5 is a perspective view showing the installation of an alternate form of the hard disk module in one receiving chamber inside a mainframe shell for notebook computer according to the present invention.

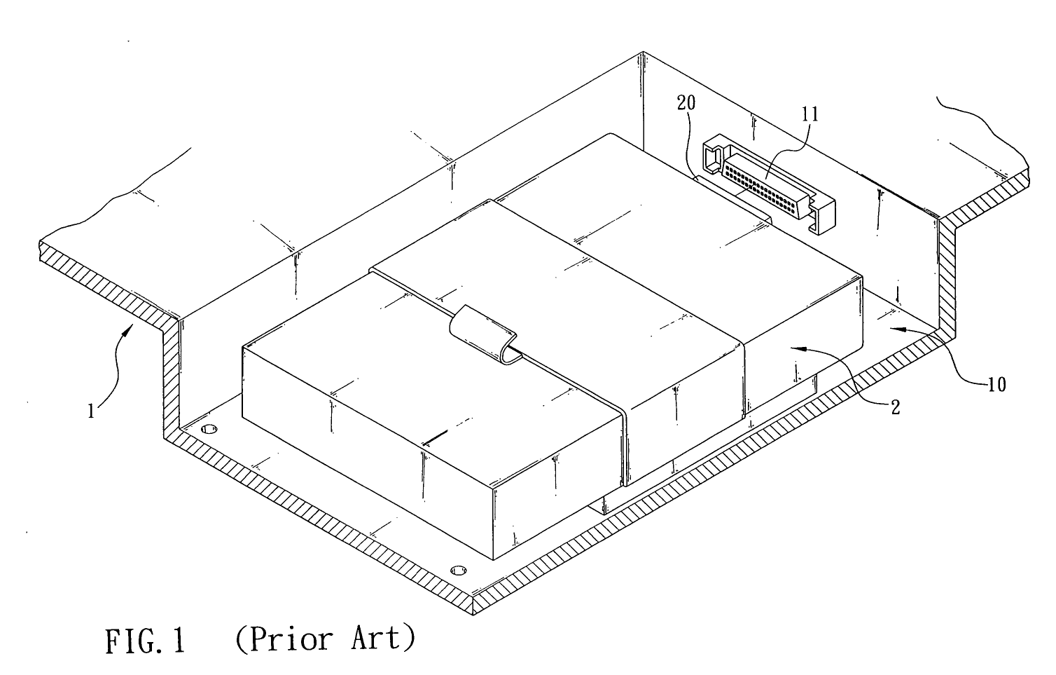

### DETAILED DESCRIPTION OF THE PREFERRED EMBODIMENT

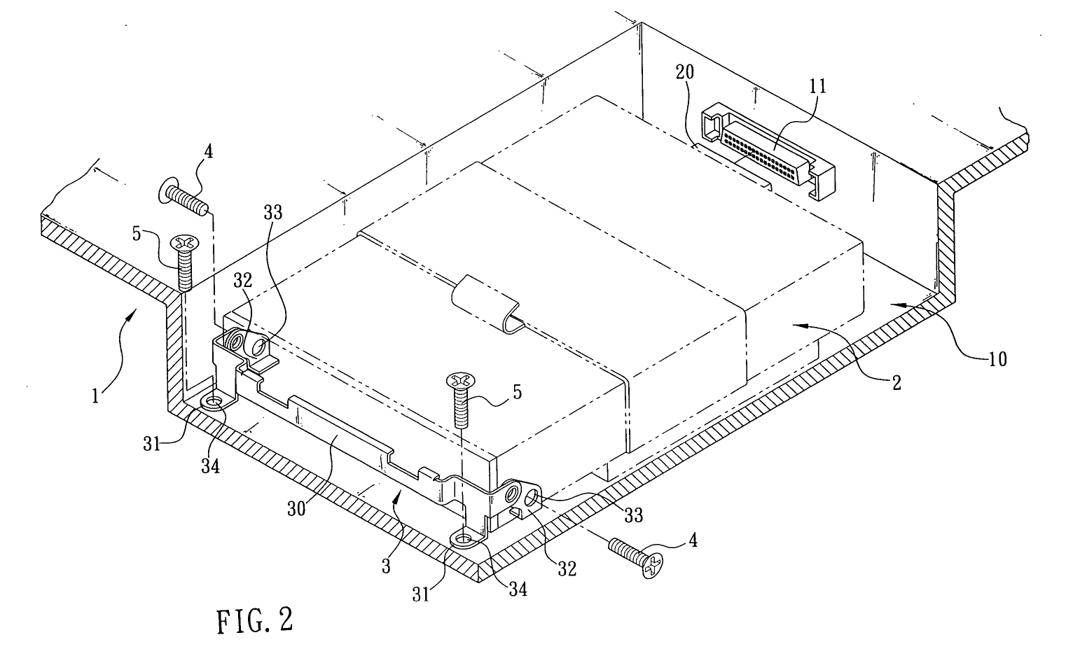

Referring to FIG. 2, the mainframe shell 1, referenced by the mainframe shell 1, has at least one receiving chamber 10 adapted to accommodate a respective hard disk module 2, a connector 11 disposed in each receiving chamber 10 and electrically coupled to the motherboard inside the mainframe shell 1. When a hard disk module 2 installed in one receiving chamber 10, the I/O port 20 of the hard disk module 2 is connected to the connector 11 in the receiving chamber 10, and therefore the hard disk module 2 is electrically connected to the motherboard inside the mainframe shell 1. The hard disk module 2 is provided with a mounting structure 3 disposed at one end opposite to the I/O port 20 for fastening to the receiving chamber 10. When unfastened the mounting structure 3, the hard disk module 2 can then be pushed away from the connector 11 and taken out of the receiving chamber 10.

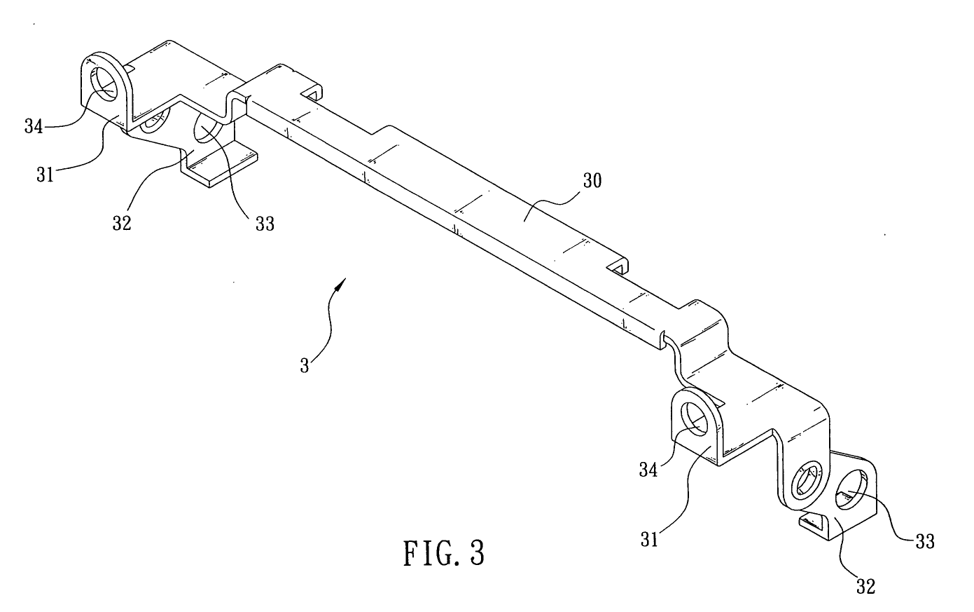

Referring to FIG. 3 and FIG. 2 again, the mounting structure 3 comprises a mounting bar 30, and two brackets 32 respectively pivoted to the two distal ends of the mounting bar 30. The mounting bar 30 has at least one lug 31 at each of the two ends. The brackets 32 are respectively affixed to the two opposite lateral sidewalls of the hard disk module 2 near one end opposite to the I/O port 20. After installation of the mounting structure 3 in the hard disk module 2, the mounting bar 30 can be turned about the axis passing through the pivot points between the mounting bar 30 and the brackets 32.

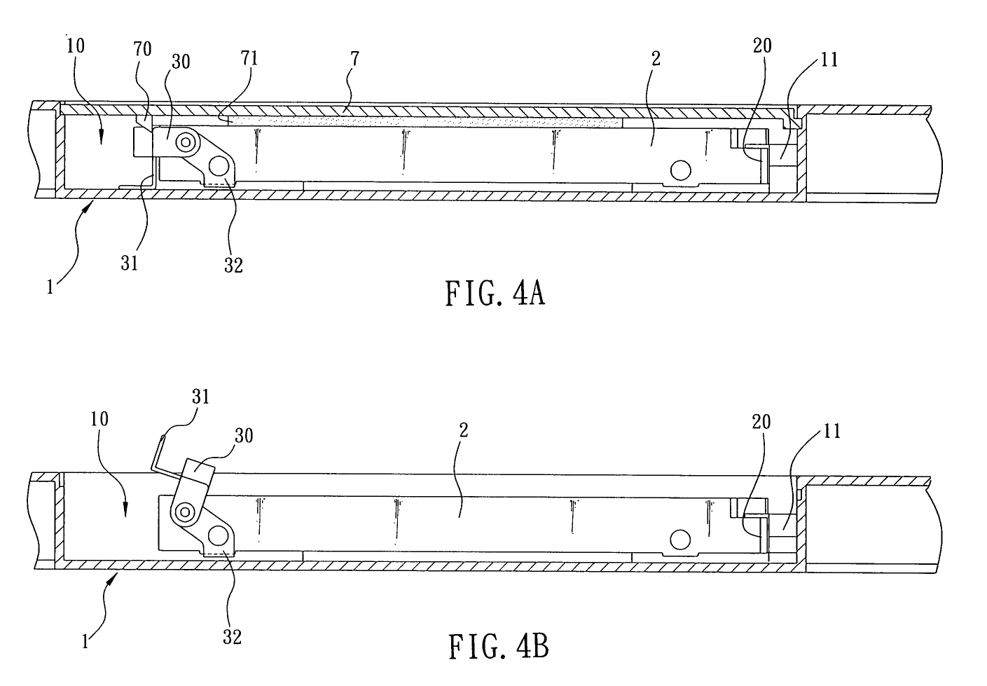

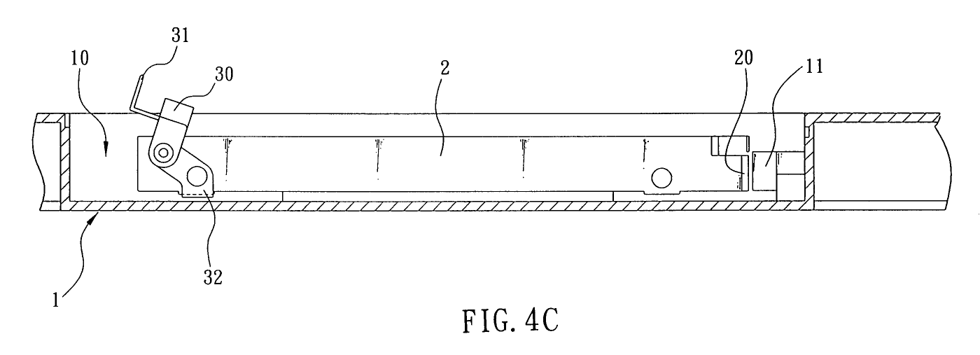

Referring to FIGS. 4A˜4C and FIGS. 2 and 3 again, because the brackets 32 are affixed to the hard disk module 2, the mounting bar 30 can be turned relative to the hard disk module 2 to the desired angle after connection of the I/O port 20 of the hard disk module 2 to the connector 11 in the receiving chamber 10 inside the mainframe shell 1, for enabling the lugs 31 to be affixed to the receiving chamber 10. Thus, as shown in FIG. 4A, the two ends of the hard disk module 2 are respectively secured to the receiving chamber 10 by the I/O port 20 and the mounting structure 3. When disconnecting the lugs 31 from the mainframe shell 1, as shown in FIG. 4B, the mounting bar 30 can be turned to a particular angle, for enabling the hard disk module 2 to be pushed in direction away from the connector 11 to disconnect the I/O port 20 from the connector 11, as shown in FIG. 4C. After disconnection of the I/O port 20 from the connector 11, the two ends of the hard disk module 2 are released from the receiving chamber 10, and the user can then easily remove the hard disk module 2 from the receiving chamber 10.

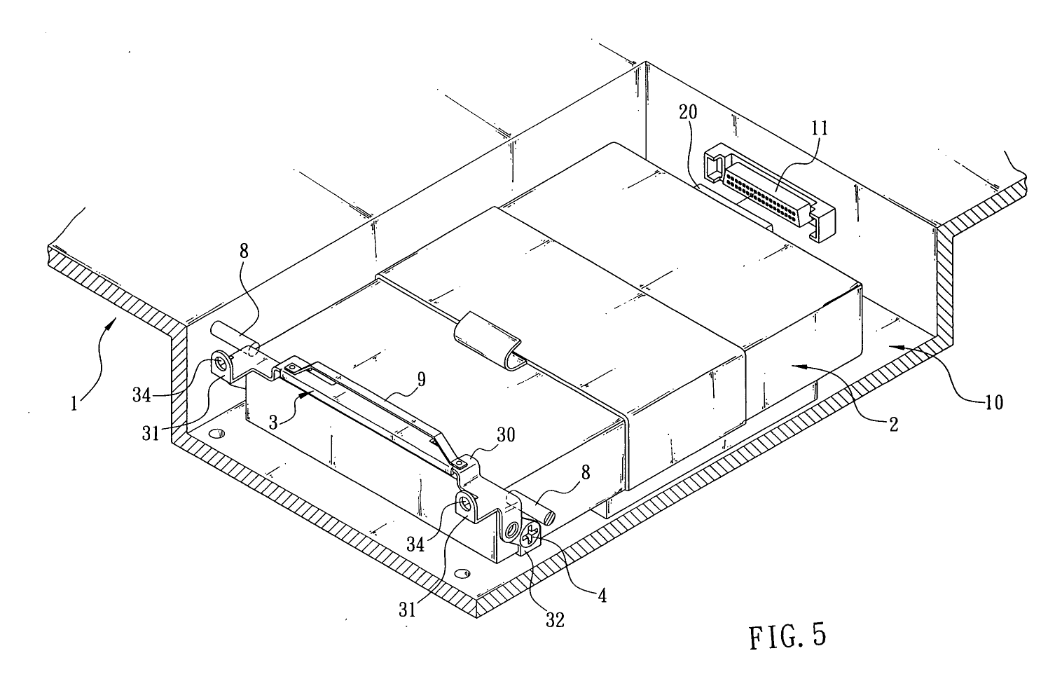

Referring to FIG. 2 and FIG. 5 again, the two brackets 32 each have a mounting hole 33. The hard disk module 2 has two screw holes (not shown) at two sides corresponding to the mounting holes 33 of the brackets 32. Fastening members, for example, screws 4 are respectively mounted in the mounting holes 33 of the brackets 32 and threaded into the screw holes of the hard disk module 2 to fixedly secure the brackets 32 to the hard disk module 2.

Referring to FIG. 2 and FIG. 5 again, each lug 31 of the mounting bar 30 has a mounting hole 34. The receiving chamber 10 has a plurality of screw holes (not shown) corresponding to the mounting holes 34 of the lugs 31 of the mounting bar 30. Fastening members, for example, screws 5 are respectively mounted in the mounting holes 34 of the lugs 31 and threaded into the screw holes of the receiving chamber 10 to affix the mounting structure 3 to the receiving chamber 10 inside the mainframe shell 1.

Referring to FIG. 4A again, the receiving chamber 10 of the mainframe shell 1 is covered with a cover 7. The cover 7 has at least one retaining block 70. When closing the cover 7 on the receiving chamber 10, each retaining block 70 is respectively forced into engagement with a respective recessed portion at the mounting bar 30 to hold down the hard disk module 2 in the receiving chamber 10. Further, the cover 7 has spongy means, for example, a sponge 71 disposed at an inner side. When the cover 7 installed in the mainframe shell 1, the sponge 71 is pressed on the hard disk module 2 to hold down the hard disk module 2 in the receiving chamber 10.

Referring to FIG. 5, two stop means, for example, stop rods 8 are symmetrically bilaterally provided inside the receiving chamber 10 remote from the connector 11. When turning the mounting bar 30 upwardly backwards to a certain position after disconnection of the lugs 31 from the mainframe shell 1, the mounting bar 30 will be stopped against the stop rods 8 to produce a resisting force that pushes the hard disk module 2 in direction away from the connector 11, thereby causing the I/O port 20 to be disconnected from the connector 11.

Referring to FIG. 5 again, the mounting bar 30 is provided with a handle 9 through which the user can turn the mounting bar 30 with the hand conveniently.

A prototype of hard disk module mounting structure for notebook computer has been constructed with the features of FIGS. 2˜5. The hard disk module mounting structure for notebook computer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A hard disk module mounting structure provided at one end of a hard disk module receivable in one receiving chamber of the mainframe shell of a notebook computer for fastening to the mainframe shell to secure said hard disk module to the inside of said receiving chamber after connection of an I/O port of said hard disk module to a connector inside said receiving chamber, the hard disk module mounting structure comprising:
two brackets respectively fixedly fastened to two opposite lateral sidewalls of said hard disk module near one end remote from said I/O port;
a mounting bar pivotally connected between said brackets; and
at least one lug fixedly extended from one side of said mounting bar for fastening to said receiving chamber.

2. The hard disk module mounting structure as claimed in claim 1, wherein said brackets each have a mounting hole respectively fastened to a respective screw hole at each of the two opposite lateral sidewalls of said hard disk module with a respective fastening member.

3. The hard disk module mounting structure as claimed in claim 1, wherein said at least one lug each has a mounting hole fastened to a respective screw hole inside said receiving chamber with a respective fastening member.

4. The hard disk module mounting structure as claimed in claim 1, further comprising a cover adapted to cover said receiving chamber, said cover comprising at least one retaining member, which is engaged into a respective recessed portion at said mounting bar after installation of said hard disk module in said receiving chamber and closing of said cover on said receiving chamber.

5. The hard disk module mounting structure as claimed in claim 1, further comprising a cover adapted to cover said receiving chamber, said cover comprising spongy means, which is pressed on said hard disk module after installation of said hard disk module in said receiving chamber and closing of said cover on said receiving chamber.

6. The hard disk module mounting structure as claimed in claim 5, wherein said spongy means is a sponge.

7. The hard disk module mounting structure as claimed in claim 1, wherein said mounting bar has a handle disposed at one side opposite to said hard disk module.

8. The hard disk module mounting structure as claimed in claim 1, further comprising two stop members bilaterally provided inside said receiving chamber and adapted to stop said mounting bar and to impart a resisting force to said hard disk module in a direction away from said connector after disconnection of said at least one lug from said receiving chamber and turning of said mounting bar by the user through an angle.
